(19) United States
(12) Patent Application Publication
(10) Pub. No.: US 2009/0305031 A1
(43) Pub. Date: Dec. 10, 2009

(54) NANODIAMOND MANUFACTURE AND PROCESS FOR MAKING THEREOF

(75) Inventors: S. Charles Picardi, Souderton, PA (US); Dustin B. Doss, Lansdowne, PA (US); Richard Knight, Philadelphia, PA (US); Antonella Stravato, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: DREXEL UNIVERSITY, Philadelphia, PA (US)

(21) Appl. No.: 12/478,051

(22) Filed: Jun. 4, 2009

Related U.S. Application Data
(60) Provisional application No. 61/058,753, filed on Jun. 4, 2008.

(51) Int. Cl. B32B 5/16; B05D 1/02

(52) U.S. Cl. 428/323; 427/447; 977/701; 977/890

(57) ABSTRACT

Disclosed are novel coatings and other components of articles of manufacture featuring the inclusion of nanodiamonds therein. Also disclosed are methods of achieving such inclusion and methods of utilizing the resultant, improved articles.

### CROSS-REFERENCE TO RELATED APPLICATIONS

This application claims priority to U.S. Provisional Patent Application Ser. No. 61/058,753, filed on Jun. 4, 2008, the entirety of which is incorporated by reference herein.

### TECHNICAL FIELD

The present invention provides novel coatings and other components of articles of manufacture featuring the inclusion of nanodiamonds therein. Methods of achieving such inclusion and methods of utilizing the resultant, improved articles are also disclosed.

### BACKGROUND

The properties of surfaces may be modified by applying coatings to the surfaces. For example, the surfaces of tools may be coated to make them harder and more wear resistant, the surfaces of electronic components may be coated to increase or decrease their electrical or thermal conductivity, the surfaces of moving parts may be coated to increase or decrease their coefficients of friction, and so forth.

Among the many significant aspects of coating processes are the properties of the resultant coating and the industrial desirability of the coating process. Existing coatings, for example polymer coatings, often suffer from insufficient resistance to wear. Consequently, there exists a need for polymer coatings having an improved resistance to wear. Existing coating processes often involve toxic solvents or extreme conditions that can damage the coating material. Consequently, there also exists a need for industrially useful coating processes for applying polymer coatings having an improved resistance to various industrial, clinical, consumer, and other processing and utilization conditions.

### SUMMARY

In meeting the described challenges, articles of manufacture are disclosed herein at least one surface of which having a coating thereupon including nanodiamonds in admixture with at least one polymer. Methods are disclosed for coating at least a portion of an article including contacting the portion with nanodiamonds and at least one polymer via thermal spraying. Compositions are disclosed including polymer particles and nanodiamonds embedded in the surfaces of the polymer particles. Compositions are disclosed including polymer particles covalently bonded to functionalized nanodiamonds. Methods are disclosed for coating a surface with an article of manufacture including polymer particles and nanodiamonds embedded in the surfaces of the polymer particles.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale.

FIG. 1 depicts x-ray spectra of (a) Nylon-11/nanodiamond coating, and (b) nanodiamond powder. The inset region shows an enlargement of the three primary peaks of nanodiamond.

FIG. 2 depicts raman spectra of coating on a glass substrate (a); powder collected after the dissolution of the polymer in the coating (b); nanodiamond powder (c).

FIG. 3 depicts loading-hold-unloading-displacement curves for HVOF sprayed Nylon-11/nanodiamond coatings with varying nanodiamond loadings.

FIG. 4 depicts load-displacement curves for HVOF sprayed Nylon-11/nanodiamond coatings with varying nanodiamond loadings.

FIG. 5 depicts hardness (upper) and elastic modulus (lower) vs. displacement for HVOF sprayed Nylon-11/nanodiamond coatings with varying loadings of nanodiamond.

FIG. 6 depicts optical images of HVOF sprayed (L) pure Nylon-11 coating, and (R) Nylon-11 with 7 wt. % nanodiamond.

FIG. 7 depicts SEM image of the surface of Nylon-11 covered by UD90 (L) as-received, and (R) oxidized and HCl treated.

FIG. 8 depicts several carbon phases including nanodiamonds.

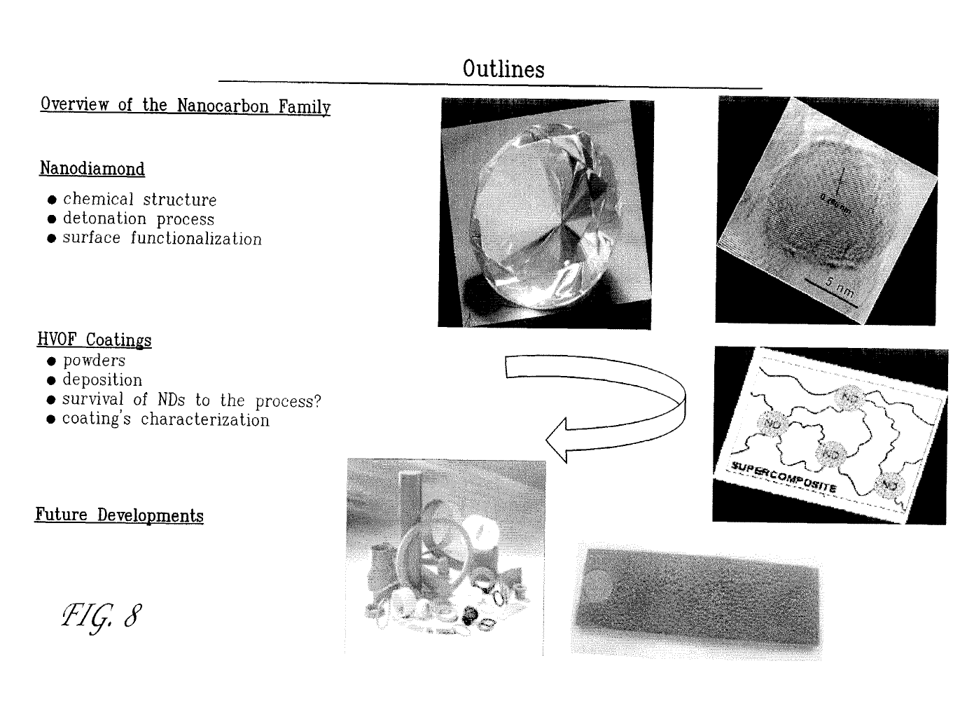

FIG. 9 depicts several carbon phases including nanodiamonds.

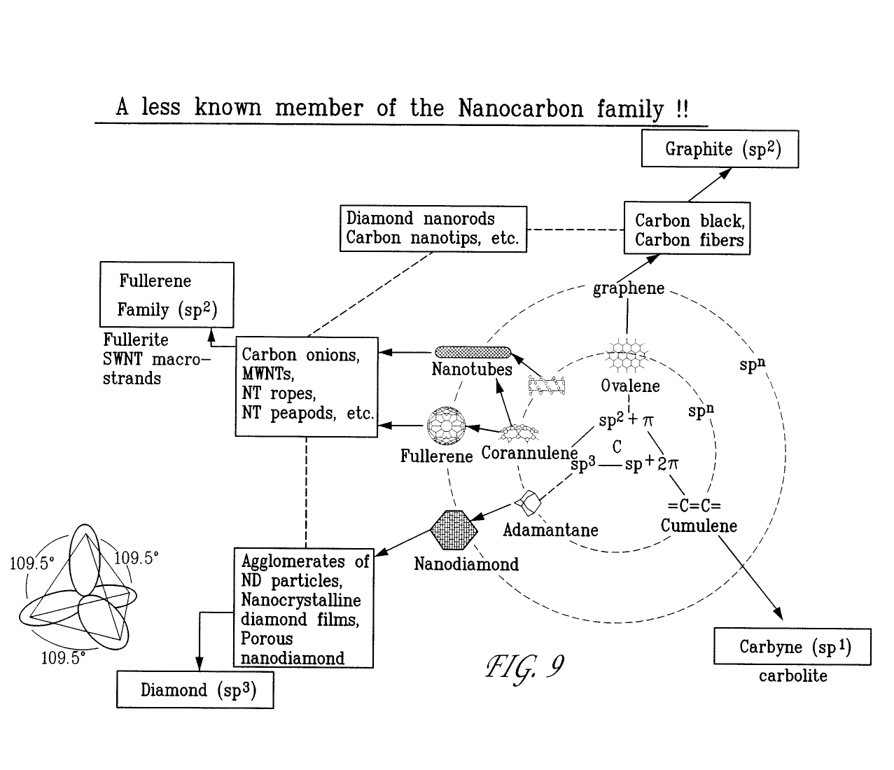

FIG. 10 depicts several carbon phases including nanodiamonds.

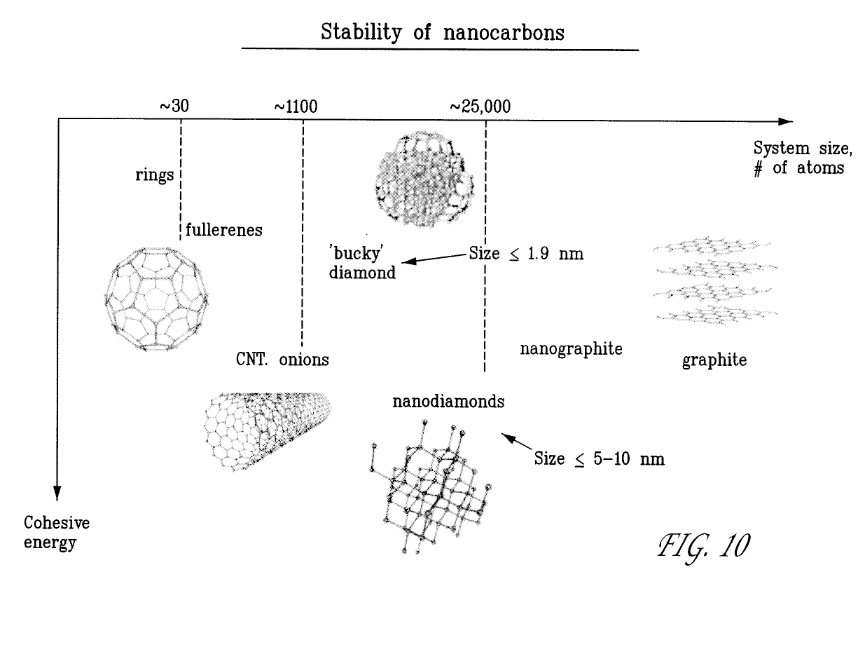

FIG. 11 depicts one example of the detonation synthesis of nanodiamonds.

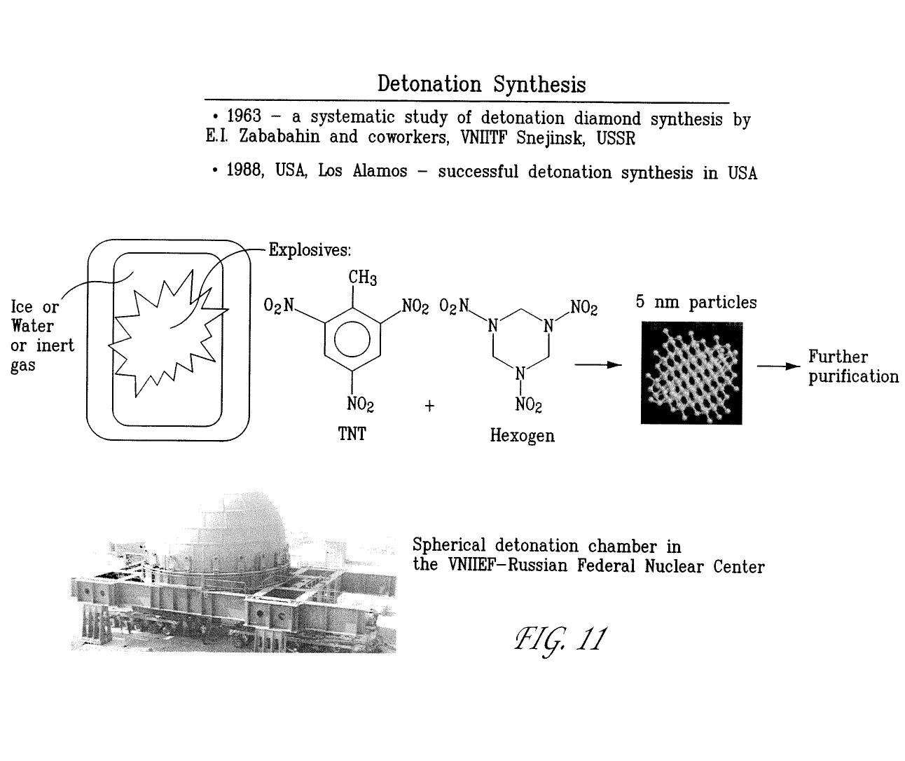

FIG. 12 depicts the synthesis region for detonation synthesis of nanodiamonds.

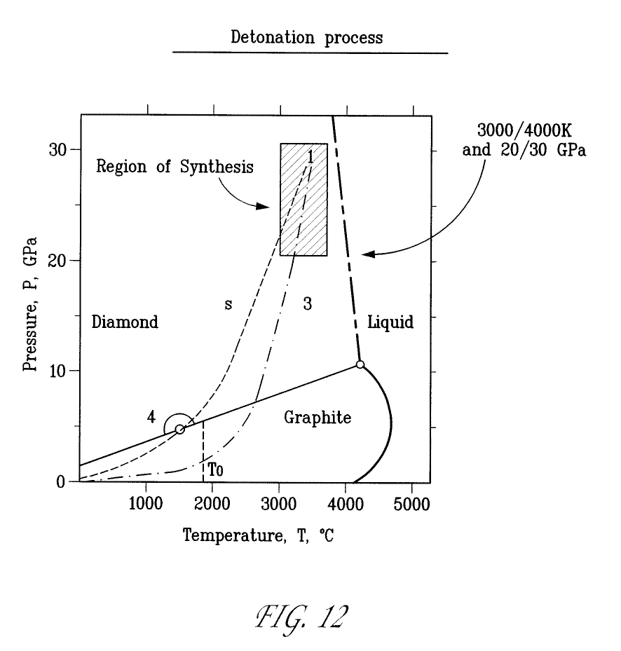

FIG. 13 depicts a carbon structure including embodiment of a nanodiamond.

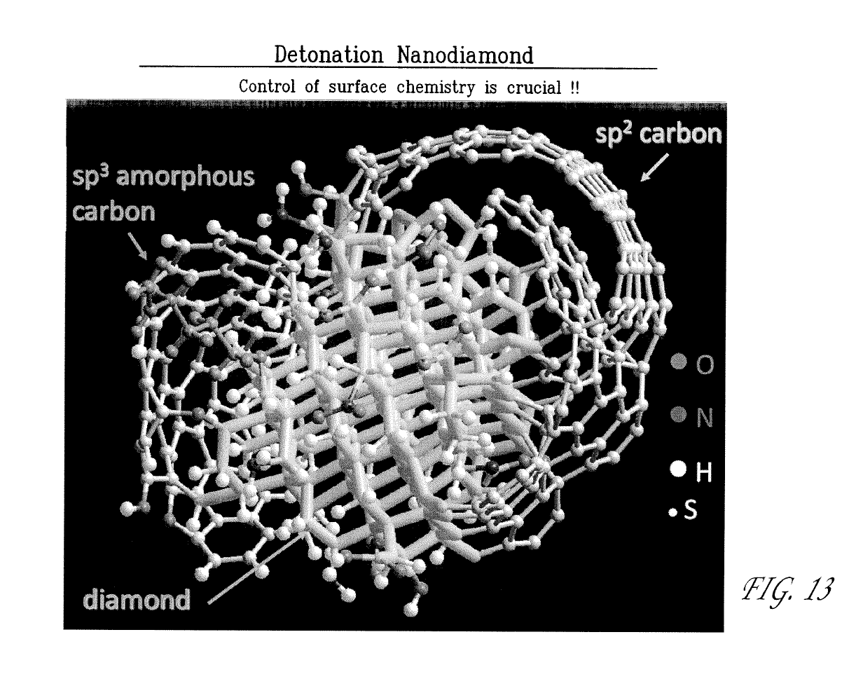

FIG. 14 depicts a carbon structure including embodiment of a nanodiamond.

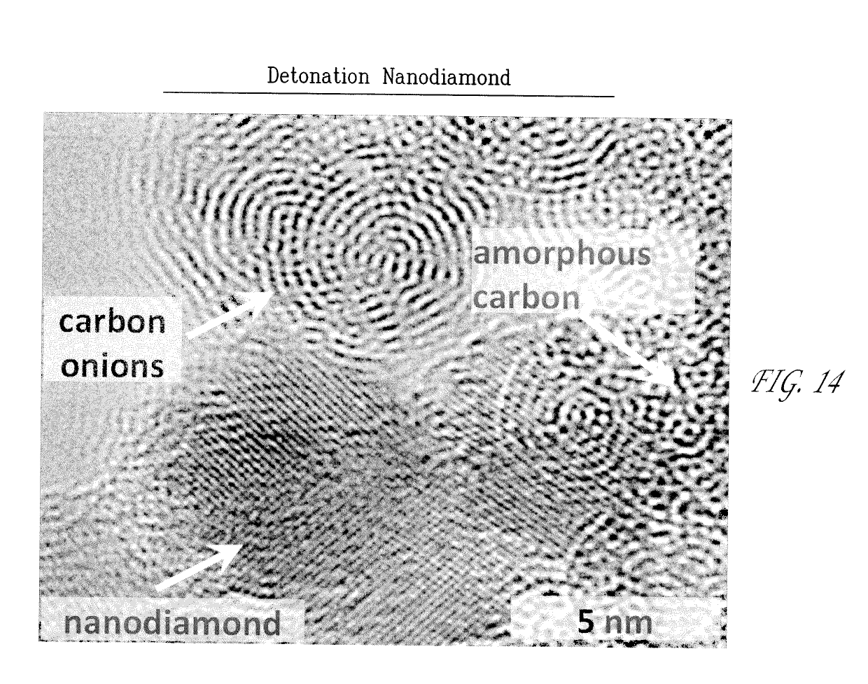

FIG. 15 depicts polyamide-11 (Nylon-11) particles and nanodiamond particles.

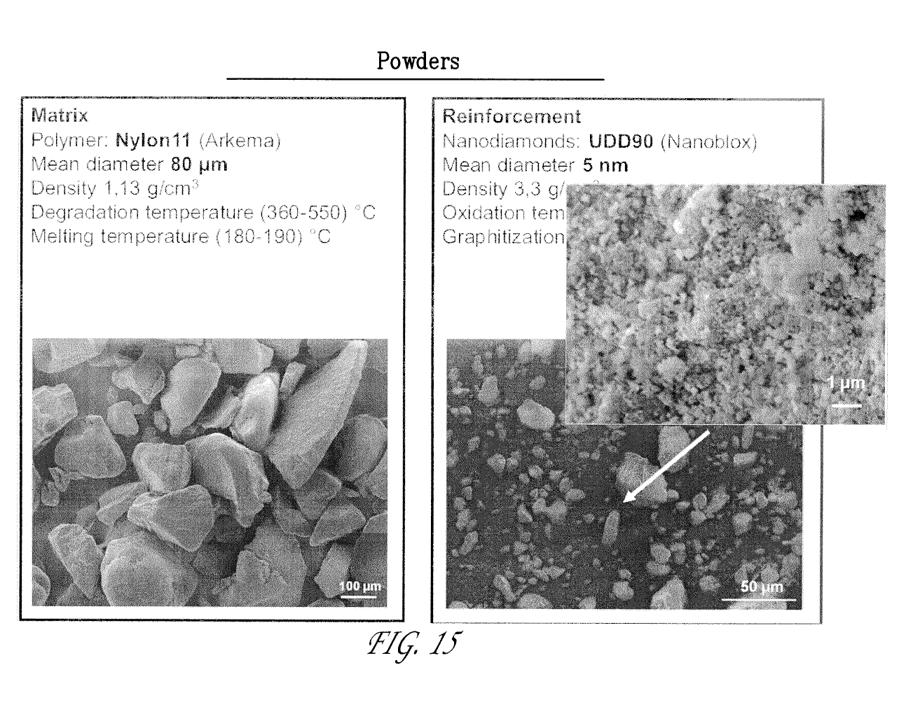

FIG. 16 depicts ball milled polymer particles.

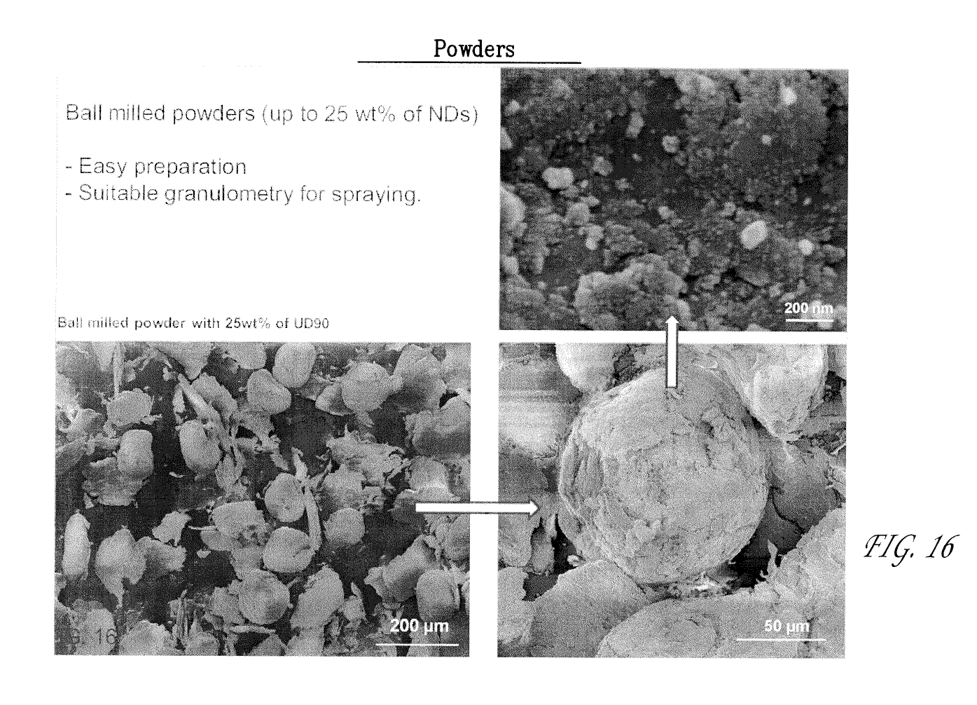

FIG. 17 depicts an embodiment of HVOF coatings.

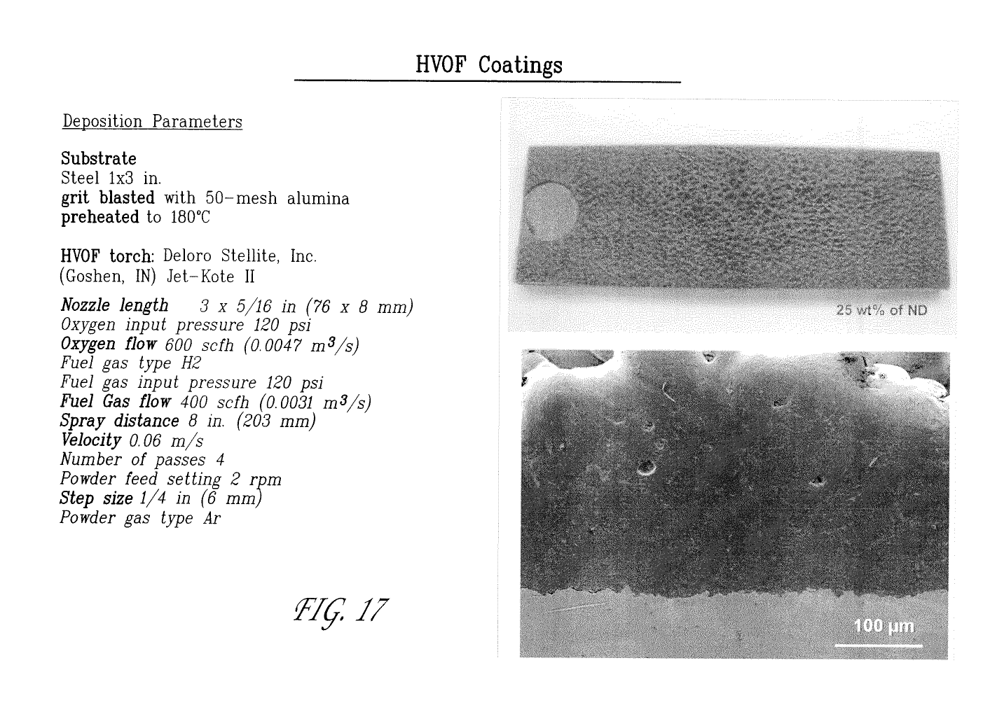

FIG. 18 depicts the XRD spectra of nanodiamond powder as-received.

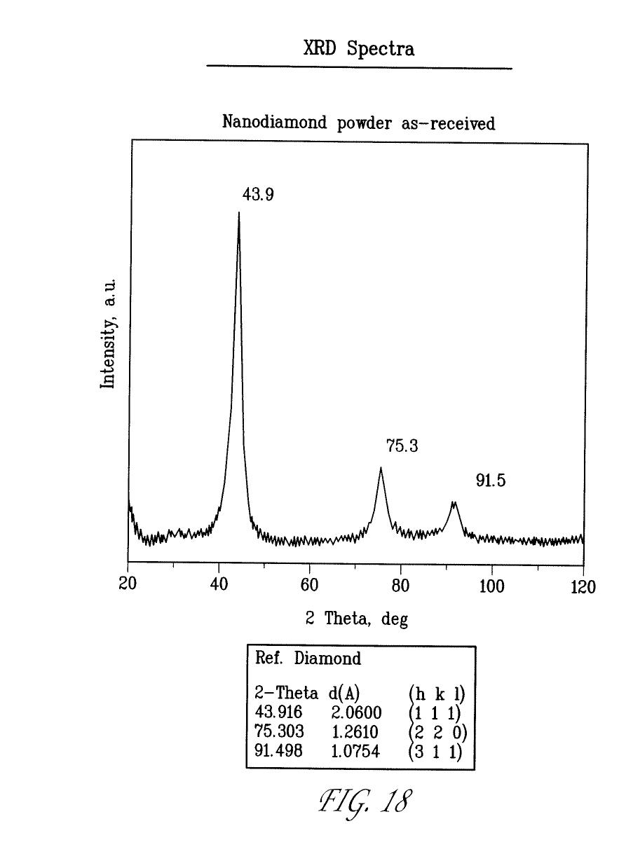

FIG. 19 depicts the XRD spectra of polyamide-11 powder as-received.

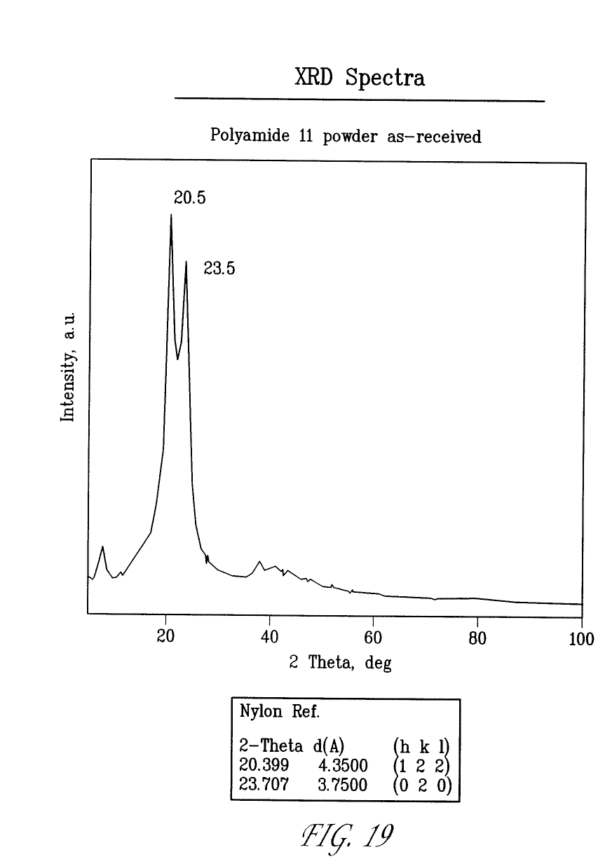

FIG. 20 depicts the XRD spectra of HVOF coatings on glass at different weight percentages of nanodiamond.

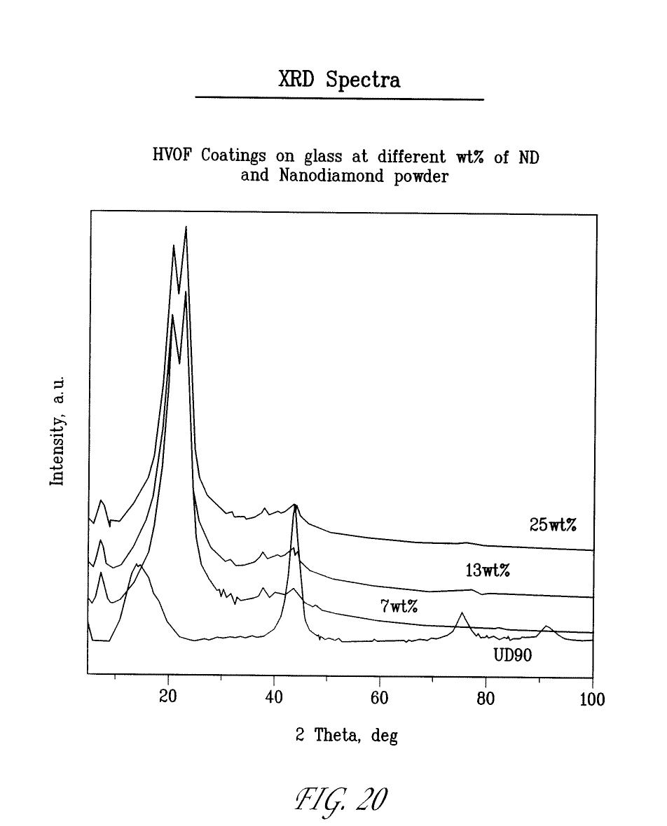

FIG. 21 depicts the XRD spectra of a nanodiamond coating.

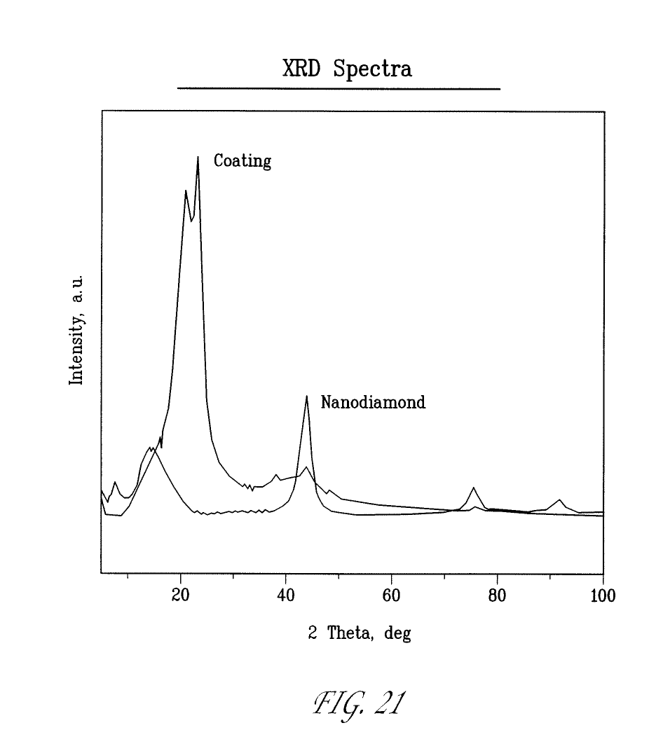

FIG. 22 depicts the Raman spectra of as-received nanodiamond powder.

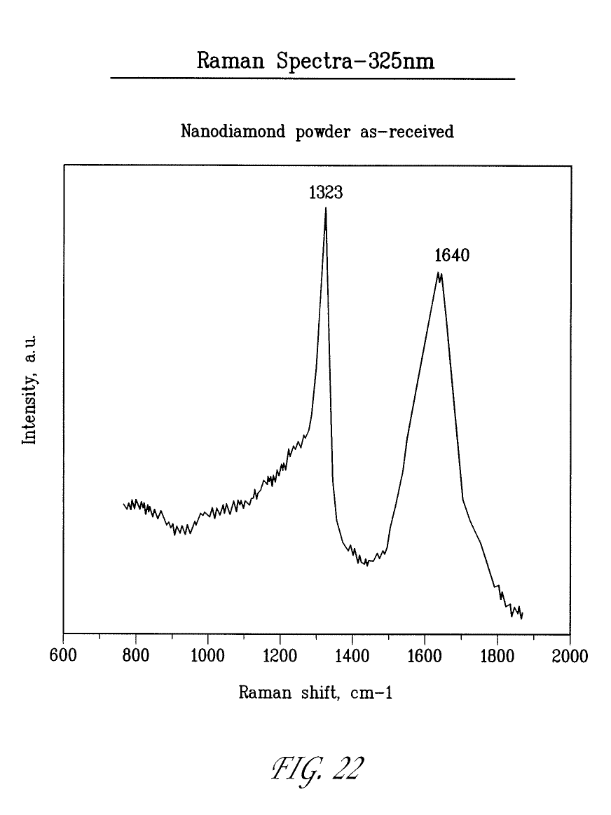

FIG. 23 depicts the Raman spectra of as-received polyamide-11 powder.

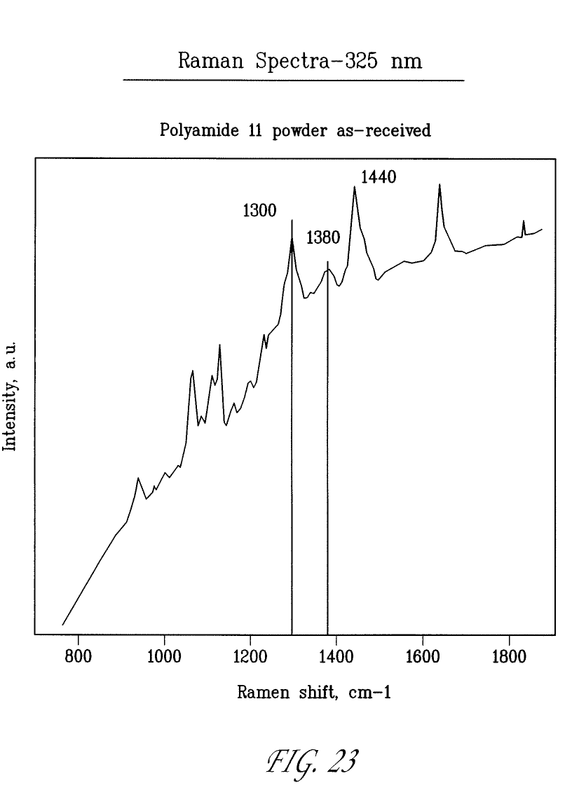

FIG. 24 depicts the Raman spectra of an HVOF coating of polyamide-11 with 25 weight percent nanodiamonds.

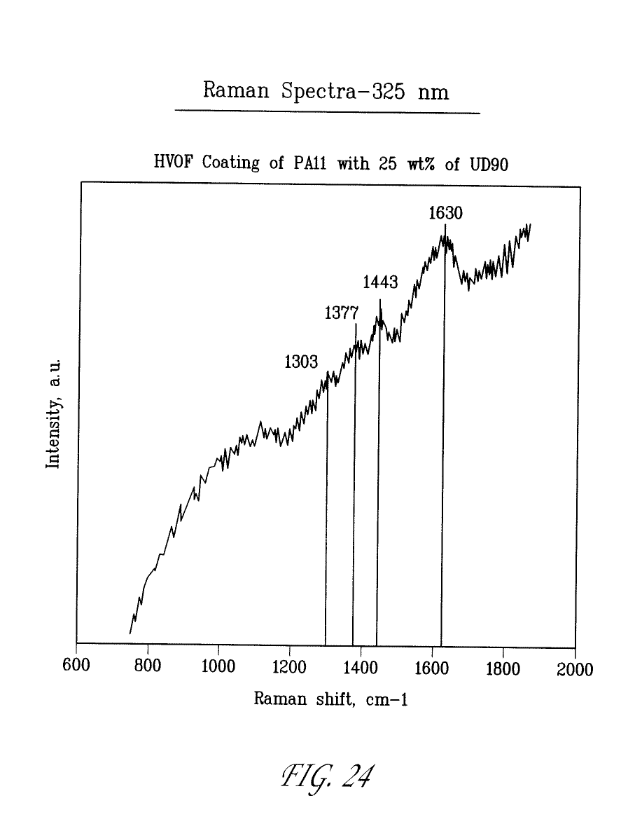

FIG. 25 depicts the Raman spectra of nanodiamond dissolved coating.

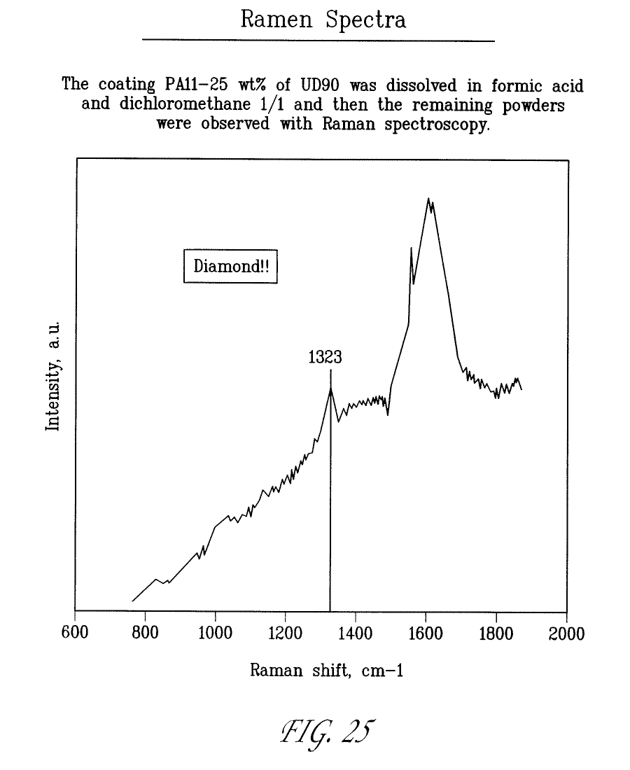

FIG. 26 depicts the Raman spectra of polyamide-11 powder, nanodiamond dissolved coating, and as-received nanodiamonds.

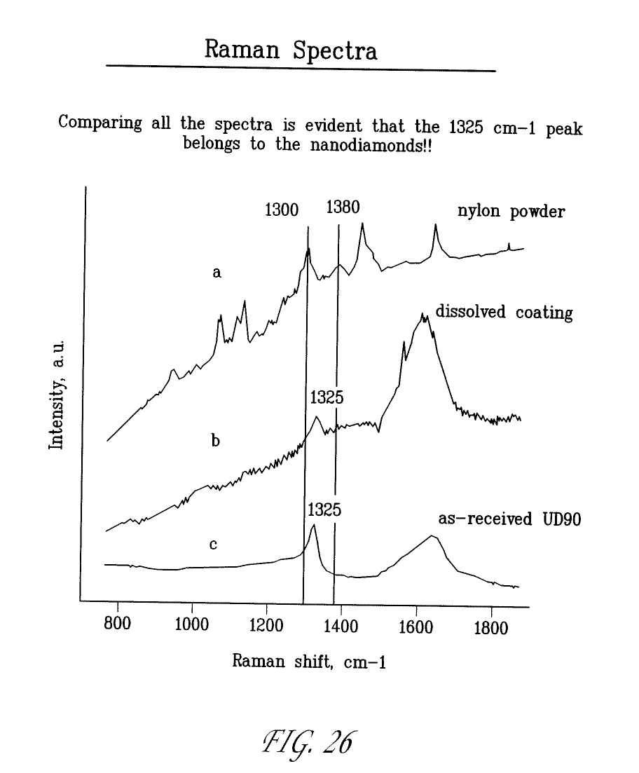

FIG. 27 depicts a nanoindentation experiment.

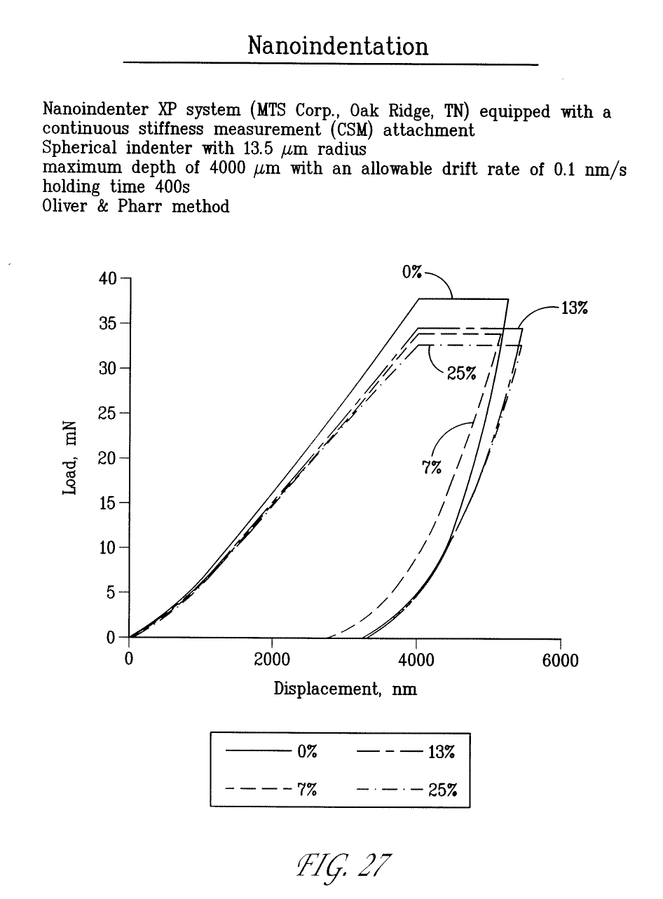

FIG. 28 depicts the results of nanoindentation experiments on several different loading levels of nanodiamond and polymer.

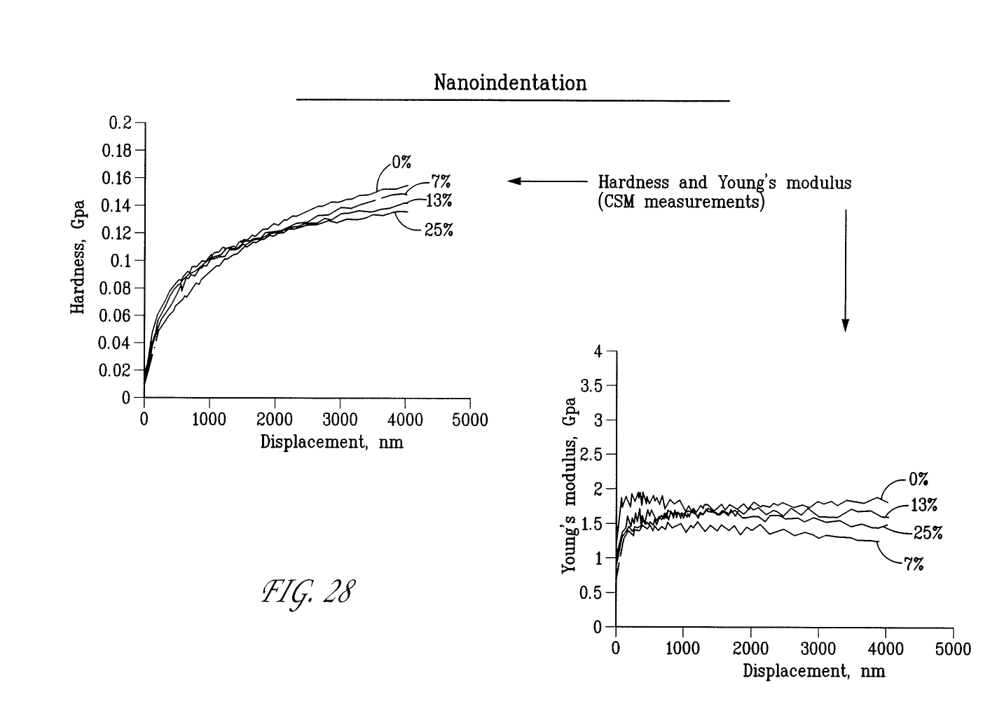

FIG. 29 depicts the surface functionalization of nanodiamonds.

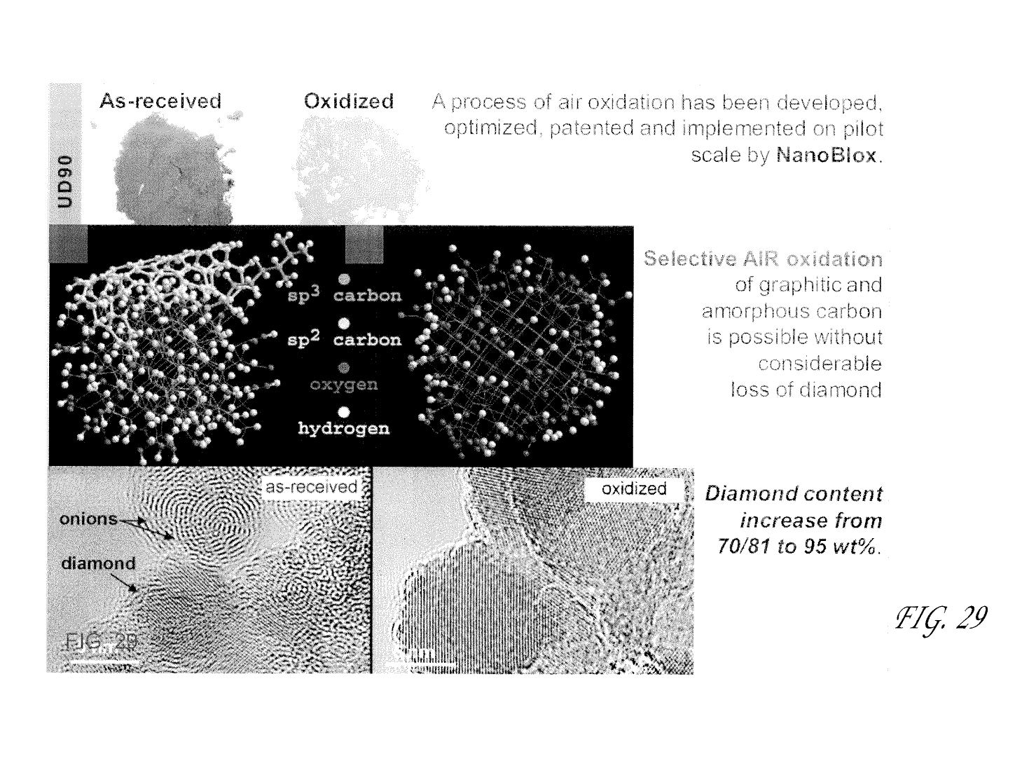

FIG. 30 depicts the treatment in HCl of nanodiamonds.

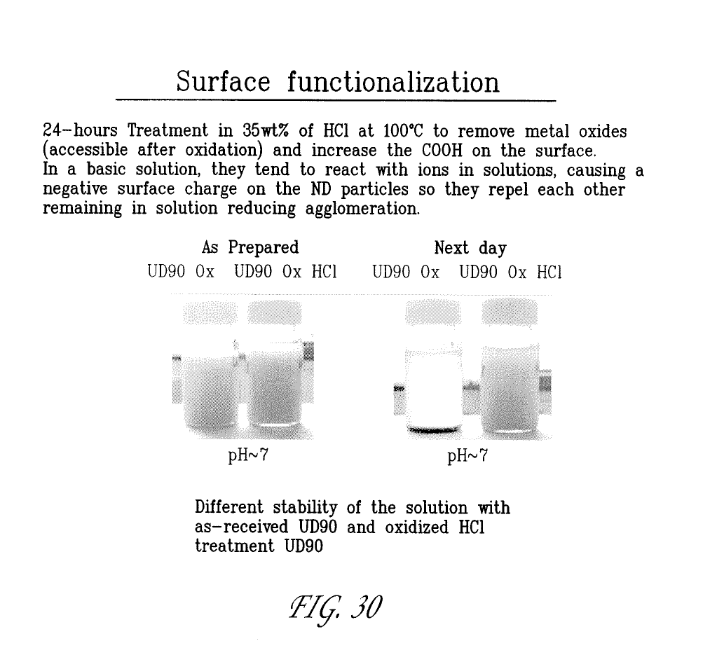

FIG. 31 depicts powders of polyamide-11 and oxidized nanodiamonds.

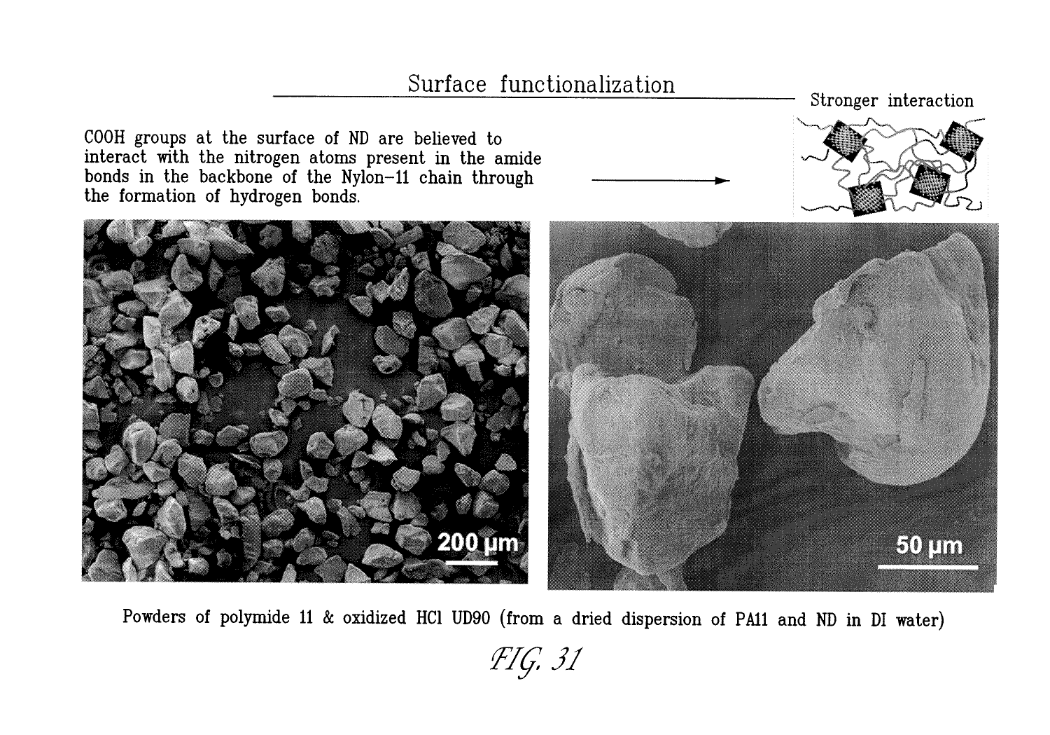

FIG. 32 depicts nanodiamonds and oxidized nanodiamonds.

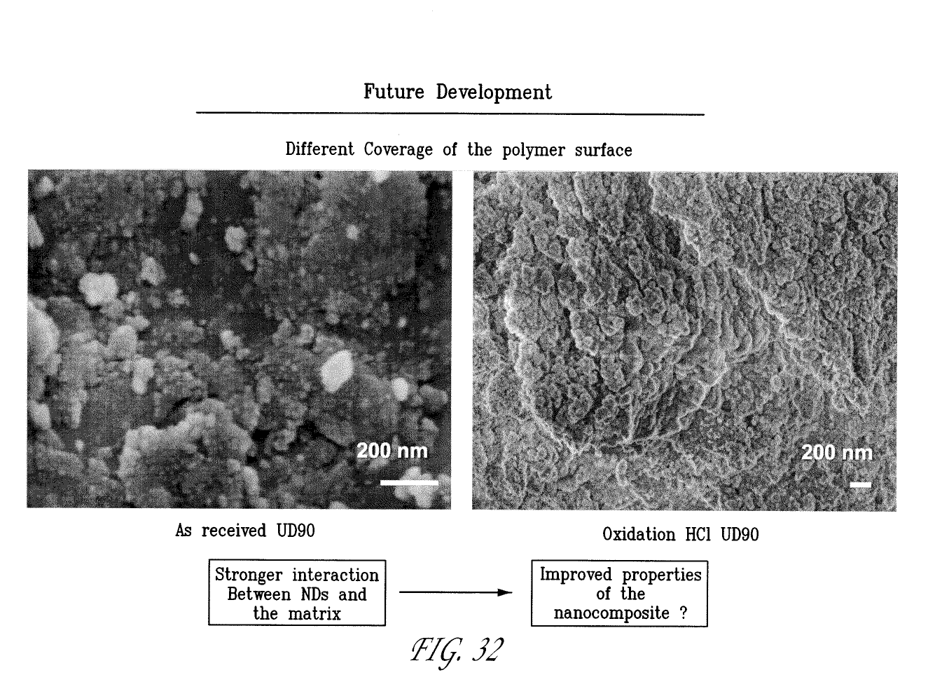

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

Nanoreinforced polymer composites are mixtures of one or more polymers and one or more nanoscale reinforcing phases. Nanoreinforced polymer composites may exhibit unique properties compared to their conventional micro-reinforced composite counterparts. Ultra-dispersed or nanocrystalline diamond, often referred as nanodiamond, may be used as a reinforcing phase in nanoreinforced polymer composites. Nanodiamonds may be a desirable reinforcing phase because, among other things, they exhibit unique properties of diamond on the nanoscale, including extreme hardness, high Young's modulus, electrical resistivity and thermal conductivity.

Nanodiamond powder may be produced by detonation synthesis from carbon-containing explosives such as trinitrotoluene and cyclotrimethylenetrinitramine at high pressure under non-equilibrium conditions. Among the possible applications of nanodiamonds are the deposition of wear- and corrosion-resistant metal coatings, additives to cooling fluids and lubricants, and polishing of ultra-flat optical or magnetic components. Among the challenges in processing nanoreinforced polymer composites are achieving a uniform dispersion and distribution of the nano phase within the polymer matrix, and improving the interfacial bonding between the nanoparticles and polymer matrix.

High-velocity oxy-fuel combustion (“HVOF”) spraying is a thermal spray technique that can be used as an environmentally-friendly solution to deposit polymers and polymer composites. HVOF spraying, known per se, may also be used to deposit, for example, polymer matrix nanocomposites incorporating, for example, ceramic phases such as silica and alumina. Thermal spraying may offer several advantages: (a) polymer melt-viscosity is not a limitation, as it would be in extrusion or injection molding, (b) thermal spraying does not require the use of volatile organic solvents, (c) thermal spray coatings can be applied in-situ or in the field, (d) high loadings of the nano-diamond reinforcing phase may be achievable, (e) thermal spray coatings are “overlay” deposits, and do not change the properties of the substrate unduly.

Employing HVOF to deposit polymer composite coatings is believed to overcome processing limitations such as melt-viscosity and the need for volatile organic solvents. The size and morphology of the nanoparticles, however, may affect their rate of heating and acceleration and, hence, the efficiency of deposition and structure and properties of the coating. Moreover, further challenges arise because nano-sized powders tend to agglomerate and can easily obstruct the feeding system, adhere to the walls of the nozzle, and be lost during spraying, resulting in a loss of material.

In one aspect of the present disclosure, the successful HVOF deposition of composite coatings including polyamide-11 (Nylon-11) and nanodiamonds has been demonstrated, preserving the structure of the nanodiamonds in the deposit microstructure. One aspect of the polymer matrix material is its industrial significance and potential utility in the powder coating industry. Nylon-11 is also one of the very few synthetic polymers produced from a natural source. A precursor for Nylon-11 is 11-aminoundecanoic acid monomer, typically synthesized from castor oil.

Among the embodiments described herein are articles of manufacture at least one surface of which having a coating thereupon comprising nanodiamonds in admixture with at least one polymer. These coatings may be applied via any thermal spraying techniques, for example via high-velocity oxy-fuel combustion spraying.

In further embodiments, at least one polymer of the coatings may be poly(ethylene), poly(propylene), thermoplastic poly(urethane), poly(amide), poly(imide), alkylene tetrafluoroethylene, or poly(carbonate). For example, the coating may comprise several polymers, or derivatives of such polymers, such as a polyamide, a polyimide, and a fluoropolymer. For example, the polymer may be polyamide-11, a derivative of polyamide-11, or a mixture of polymers, one of which is polyamide-11.

In still further embodiments, one or more nanodiamonds of the coatings may be functionalized. For example, some of the nanodiamonds may be functionalized, most of the nanodiamonds may be functionalized, or substantially all of the nanodiamonds may be functionalized. For example, the coating may include at least one nanodiamond having at least one acyl group linked to one or more surface groups. For example, the one or more surface groups may include hydrocarbon chains, an alkene, an alkyne, a monomer, an aromatic molecule, a nucleophile, a fluorescent species, an antibody, a ligand, an amine, an amino group, a thiol, a sulfur, an acid, a base, an alcohol, a monomer, a polymer, a metal, a ceramic, a protein, a nucleic acid, a biochemical, or any combination thereof.

In further embodiments, at least one nanodiamond is oxidized, for example, one or more —COOH functional groups may be present. For example, the majority of the surface functionalities may be converted to —COOH groups. The carboxyl groups at the surface of nanodiamond may interact with further species, for example the nitrogen atoms present in the amide bonds in the backbone of a Nylon-11 chain through the formation of hydrogen bonds. Thus, in some embodiments, at least one nanodiamond may be covalently bonded to at least one polymer.

The coatings may be disposed or deposited upon any organic or inorganic surface, for example, surfaces comprising a metal, a mineral, a ceramic, a polymer, or a composite. Surfaces may contain a mixture of these materials, or some of these materials as well as further materials.

In certain embodiments, at least one polymer is present in the form of polymer particles. The particles may be of various shapes and sizes, for example having a representative dimension of about 30 μm to about 120 μm, for example about 80 μm. The polymer particles may be admixed with the nanodiamonds using, for example, a tumbler, shaker, or ball mill. For example the admixture may be accomplished by dispersing nanodiamonds among particles comprising at least one polymer.

The volume percent of nanodiamonds in the admixture of nanodiamonds and at least one polymer may range from between about 0.1 percent to about 99.9 percent, for example from between about 2.5 percent to about 10 percent, for example 7.5 percent. The ratios of the components in the admixture may also be computed by weight percent, and it shall be recognized that these two measures may be converted between each other.

Various nanodiamonds may be employed in the embodiments disclosed herein. For example, at least one nanodiamond may comprise a characteristic cross-sectional dimension in the range of from about 1 nm to about 50 nm, or at least one nanodiamond may comprise a characteristic cross-sectional dimension in the range of from about 5 nm to about 20 nm.

Also disclosed are methods for coating at least a portion of an article by, among other things, contacting the portion with nanodiamonds and at least one polymer via thermal spraying. For example, the thermal spraying technique employed may be high-velocity oxy-fuel combustion spraying.

In further embodiments, at least one polymer of the coating applied by thermal spraying may be poly(ethylene), poly(propylene), thermoplastic poly(urethane), poly(amide), poly(imide), alkylene tetrafluoroethylene, or poly(carbonate). For example, the coating may comprise several polymers, or derivatives of such polymers, such as a polyamide, a polyimide, and a fluoropolymer. For example, the polymer may be polyamide-11, a derivative of polyamide-11, or a mixture of polymers, one of which is polyamide-11.

In still further embodiments, one or more nanodiamonds of the coating applied by thermal spraying may be functionalized. For example, some of the nanodiamonds may be functionalized, most of the nanodiamonds may be functionalized, or substantially all of the nanodiamonds may be functionalized. For example, the coating may include at least one nanodiamond having at least one acyl group linked to one or more surface groups. For example, the one or more surface groups may include hydrocarbon chains, an alkene, an alkyne, a monomer, an aromatic molecule, a nucleophile, a fluorescent species, an antibody, a ligand, an amine, an amino group, a thiol, a sulfur, an acid, a base, an alcohol, a monomer, a polymer, a metal, a ceramic, a protein, a nucleic acid, a biochemical, or any combination thereof.

In further embodiments, at least one nanodiamond applied by thermal spraying is oxidized, for example, one or more —COOH functional groups may be present. For example, the majority of the surface functionalities may be converted to —COOH groups. The carboxyl groups at the surface of nanodiamond may interact with further species, for example the nitrogen atoms present in the amide bonds in the backbone of a Nylon-11 chain through the formation of hydrogen bonds. Thus, in some embodiments, at least one nanodiamond may be covalently bonded to at least one polymer.

The coatings may be disposed or deposited upon any organic or inorganic surface, for example, surfaces comprising a metal, a mineral, a ceramic, a polymer, or a composite. Surfaces may contain a mixture of these materials, or some of these materials as well as further materials.

In certain embodiments of methods for thermal spraying of mixtures of nanodiamonds and polymers, at least one polymer is present in the form of polymer particles. The particles may be of various shapes and sizes, for example having a representative dimension of about 30 μm to about 120 μm, for example about 80 μm. The polymer particles may be admixed with the nanodiamonds using, for example, a tumbler, shaker, or ball mill. For example the admixture may be accomplished by dispersing nanodiamonds among particles comprising at least one polymer. In some examples, the mixture of materials to be thermally sprayed includes at least one polymer in the form of polymer particles, with nanodiamonds dispersed among the particles.

In some examples of thermal spraying mixtures of nanodiamonds and at least one polymer, the volume percent of nanodiamonds in the admixture of nanodiamonds and at least one polymer may range from between about 0.1 percent to about 99.9 percent, for example from between about 2.5 percent to about 10 percent, for example 7.5 percent. The ratios of the components in the admixture may also be computed by weight percent, and it shall be recognized that these two measures may be converted between each other.

Various nanodiamonds may be applied by thermal spraying to surfaces. For example, at least one nanodiamond may comprise a characteristic cross-sectional dimension in the range of from about 1 nm to about 50 nm, or at least one nanodiamond may comprise a characteristic cross-sectional dimension in the range of from about 5 nm to about 20 nm.

Another aspect disclosed herein includes a composition of matter comprising polymer particles and nanodiamonds embedded in the surfaces of the polymer particles. Such a composition may be created by combining nanodiamond powder with particles comprising at least one polymer, and facilitating the mixture of the materials, for example by milling them together, for example in a ball mill.

Compositions including polymer particles and nanodiamonds may include polymer particles comprising at least one of poly(ethylene), poly(propylene), thermoplastic poly(urethane), poly(amide), poly(imide), alkylene tetrafluoroethylene, or poly(carbonate). For example, the coating may comprise several polymers, or derivatives of such polymers, such as a polyamide, a polyimide, and a fluoropolymer. For example, the polymer may be polyamide-11, a derivative of polyamide-11, or a mixture of polymers, one of which is polyamide-11.

In still further embodiments, compositions including nanodiamonds may include functionalized nanodiamonds. For example, some of the nanodiamonds may be functionalized, most of the nanodiamonds may be functionalized, or substantially all of the nanodiamonds may be functionalized. For example, the coating may include at least one nanodiamond having at least one acyl group linked to one or more surface groups. For example, the one or more surface groups may include hydrocarbon chains, an alkene, an alkyne, a monomer, an aromatic molecule, a nucleophile, a fluorescent species, an antibody, a ligand, an amine, an amino group, a thiol a sulfur, an acid, a base, an alcohol, a monomer, a polymer, a metal, a ceramic, a protein, a nucleic acid, a biochemical, or any combination thereof.

In further embodiments, compositions including nanodiamonds may include at least one nanodiamond that is oxidized, for example, one or more —COOH functional groups may be present. For example, the majority of the surface functionalities may be converted to —COOH groups. The carboxyl groups at the surface of nanodiamond may interact with further species, for example the nitrogen atoms present in the amide bonds in the backbone of a Nylon-11 chain through the formation of hydrogen bonds. Thus, in some embodiments, at least one nanodiamond may be covalently bonded to at least one polymer.

In certain embodiments of compositions including polymer particles and nanodiamonds, at least one polymer is present in the form of polymer particles. The particles may be of various shapes and sizes, for example having a representative dimension of about 30 μm to about 120 μm, for example about 80 μm. The polymer particles may be admixed with the nanodiamonds using, for example, a tumbler, shaker, or ball mill. For example the admixture may be accomplished by dispersing nanodiamonds among particles comprising at least one polymer.

In some examples compositions including nanodiamonds and at least one polymer, the volume percent of nanodiamonds in the admixture of nanodiamonds and at least one polymer may range from between about 0.1 percent to about 99.9 percent, for example from between about 2.5 percent to about 10 percent, for example 7.5 percent. The ratios of the components in the admixture may also be computed by weight percent, and it shall be recognized that these two measures may be converted between each other.

Compositions including nanodiamonds may include nanodiamonds of various sizes, for example at least one nanodiamond may comprise a characteristic cross-sectional dimension in the range of from about 1 nm to about 50 nm, or at least one nanodiamond may comprise a characteristic cross-sectional dimension in the range of from about 5 nm to about 20 nm.

Compositions including functionalized nanodiamonds and polymer particles may be produced, for example, by drying a solution comprising water, the oxidized nanodiamonds, and the polymer particles.

The compositions disclosed herein may be present at ambient conditions, or may be heated above ambient conditions and accelerated via a thermal spraying process, for example high-velocity oxy-fuel combustion spraying.

This work has demonstrated, among other things, the feasibility of producing polymer matrix nanocomposites incorporating 5 nm size diamond as the reinforcing phase via high velocity oxy-fuel spraying. In certain examples, x-ray diffraction and Raman spectroscopy confirmed the presence of nanodiamonds in the sprayed deposits. In further examples, qualitative assessment indicated that coating adhesion was improved through the addition of the nanodiamond to the Nylon-11 matrix.

The feedstock to the thermal spray operation may be varied and optimized, as may techniques for covalently bonding the nanodiamond phase to the polymer matrix, as may techniques for characterizing the improvement in properties as a function of nanodiamond loading.

These results indicate significant promise for this new material system, and should lead to future applications of these materials. Nanodiamonds may also be used in place of, or in addition to, more conventional reinforcing phases, such as WC or Cr₃C₂, where their extreme hardness, low coefficient of friction, high thermal conductivity and modest cost may enable more environmentally friendly and improved wear resistance coatings to be developed.

### Examples

Semicrystalline Nylon-11 (Polyamide-11) powder, available commercially as RILSAN D, “French Natural ES” (donated by Arkema, Inc., King of Prussia, Pa.) with nominal 80 μm particle size (designated D80), was selected as the feedstock for the experiments.

Nanodiamond (ND) powder (UD90 grade) produced by detonation synthesis was supplied by NanoBlox, Inc., (Boca Raton, Fla., USA). The as-produced powder was purified by the manufacturer using a multistage acid treatment using nitric and sulfuric acids. The sp3 carbon content in the powder was above 70 wt. %. The remaining 30% was other carbon species, mainly amorphous and graphitic carbon, together with metallic impurities such as calcium, iron, aluminum, magnesium and copper, surrounded by carbon shells. The surfaces of the ND particles were rich in various functional groups, such as —COOH, —CHn and —OH. Oxidized UD90 nanodiamond was produced from UD90 though an oxidative purification in air at 425° C. to selectively remove the non-diamond carbon phases. The oxidized UD90 powder was subsequently treated with HCl to remove metal impurities.

Two feedstock preparation routes were explored. Initially, Nylon-11 powder was dry ball-milled together with as-received UD90 nanodiamond powder for 48 h in a Norton Ball Mill using zirconia balls. The milling procedure mechanically embedded the hard reinforcement particles into the surfaces of the Nylon powder particles, but did not uniformly disperse or distribute the nano-particulates within the polymer matrix. Composite powders with 2.5 to 10 vol. % (7 to 25 wt. %) nanodiamond loadings were produced for subsequent spray consolidation, as described below.

Nylon-11/nanodiamond composite powders with the latter covalently bonded to the polymer matrix were also prepared by mixing the oxidized and HCl-treated nanodiamond powder with Nylon-11 in deionized water, stirring and sonicating, followed by drying on a hot plate, to produce composite powders.

Spraying of the two composite feedstock powders was carried out using a Deloro Stellite, Inc. (Goshen, Ind.) Jet-Kote II® HVOF combustion spray system using oxygen and hydrogen flow rates of 0.0024 and 0.0039 m³/s (300 and 500 scfh), respectively, and a spray distance of 200 mm. Nitrogen was used as powder carrier gas at as flow rate of 0.4 10-4 m³s⁻¹ (60 scfh). A 76 mm long 6 mm ID (3 in×0.25″) spray nozzle was used. The materials were deposited using gun traverse speed of ˜0.06 m/s, with external compressed air substrate cooling (410 kPa or 60 psi) with a 6 mm step size between passes. Coatings were deposited onto 1018 steel substrates, grit blasted prior to spraying using 50-mesh alumina grit. The substrates were preheated using the HVOF jet to ˜180° C. before spraying.

Cross-sectional samples of the sprayed coatings were prepared using standard metallographic techniques: sectioning, mounting and polishing with 400 and 600 grit SiC papers and 5 μm alumina powder.

Raman spectra were recorded using a Renishaw Model 1000 spectrometer (Renishaw, UK) with an excitation wavelength of 325 nm (He—Cd laser) in a back-scatter configuration. Each Raman spectrum obtained was an average of 3 accumulations with 300 s accumulation time. To minimize the thermal destruction of the samples caused by the UV laser, the samples were immersed in deionized water during exposure to the laser. Spectra were analyzed using the Renishaw Wire 2.0 software.

X-Ray Diffraction analysis was performed using a Siemens D500 X-Ray powder diffractometer (Cu Kα, λ=1.54056 Å) with a step size of 0.02° (2θ) and hold time of 1 s. Results were analyzed using the MDI Jade 7 (MDI, Livermore, Calif.) software.

Room temperature mechanical properties of the sprayed polymer/nanodiamond deposits were studied by nanoindentation using a Nanoindenter XP system (MTS Corp., Oak Ridge, Tenn.) equipped with a continuous stiffness measurement (CSM) attachment. Each sample was indented 10 times using a conical indenter with a 13.5 μm radius spherical tip, indenting to a maximum depth of 4000 μm with an allowable drift rate of 0.1 nm/s.

Using the Oliver and Pharr model, the contact depth h_{c} and hence the contact radius a were determined according to the following equations

$$\begin{matrix}{h}_{c} = h - ɛ \frac{P}{S} & ( 1 ) \\ a = \sqrt{2 {h}_{c} R - {h}_{c}^{2}} & ( 2 )\end{matrix}$$

where h is the total displacement, S the contact stiffness measured by the CSM and ε a geometric constant that is 0.75 for a spherical indenter. From Hertz's theory Eᵣ can be calculated as:

$${E}_{r} = \frac{\sqrt{π}}{2} \frac{S}{\sqrt{A}} \qquad ( 3 )$$

where Er is the reduced modulus, and Er is also given by

$${E}_{r} = [ \frac{1 - {v}_{i}^{2}}{{E}_{i}} + \frac{1 - {v}_{s}^{2}}{{E}_{s}} ] \qquad ( 4 )$$

where i and s refer to the indenter and specimen, respectively.

The hardness H is defined as the indentation load divided by the projected contact area A=πa2

$$H = \frac{P}{A} \qquad ( 5 )$$

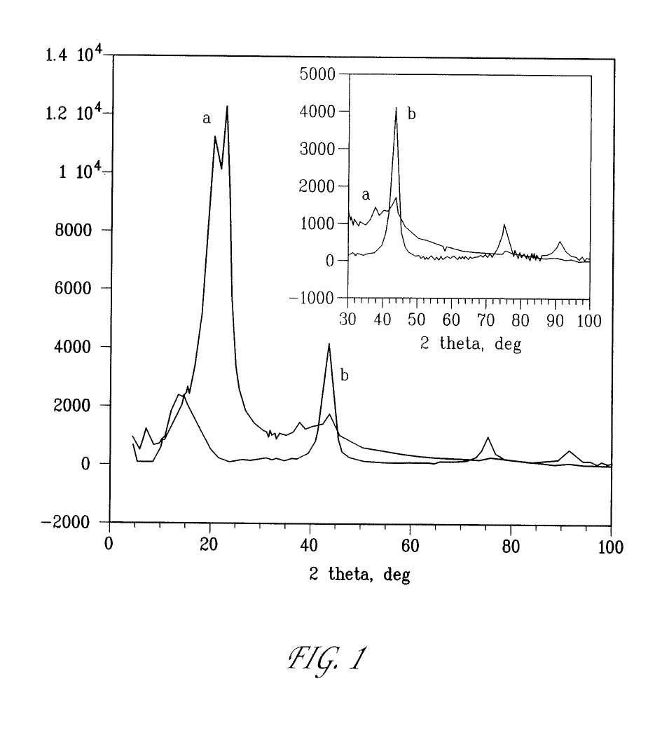

X-ray diffraction (XRD) and Raman spectroscopy were used to confirm the retention and presence of nanodiamonds in the coatings after HVOF spraying. XRD patterns of a 13 wt. % ND-Nylon-11 coating sprayed onto glass are shown in FIG. 1. Samples for XRD analysis were sprayed on glass substrates, rather than steel, to eliminate X-ray peaks from the steel determined to be close to the expected peaks for diamond. The peaks shown at 20.5° and 23.5° were related to the polymer. Curve b shows the XRD diffraction pattern of the nanocrystalline diamond powder. The same diffraction peaks were present in the XRD spectra of the coating (curve a) confirming the presence of diamond in the deposited coating.

Additional confirmation of the presence of nanodiamonds in the HVOF sprayed coatings was obtained via UV Raman spectroscopy. The UV Raman spectrum of a typical ND powder exhibits the following characteristic features: the G band at ˜1610 cm¹ originating from sp2 hybridized carbon; the disorder-induced double-resonance D band of graphitic carbon around 1400 cm⁻¹, and the broadened and downshifted, with respect to the Raman mode of a single diamond crystal (1332 cm⁻¹), diamond peak at ˜1325 cm⁻¹. The G band in the Raman spectrum of ND powders results from an overlap of the Raman signal of sp2 carbon, such as amorphous carbon, carbon onions and fullerene-like shells, usually giving rise to the Raman intensity below 1583 cm⁻¹ and a peak around 1620-1630 cm⁻¹.

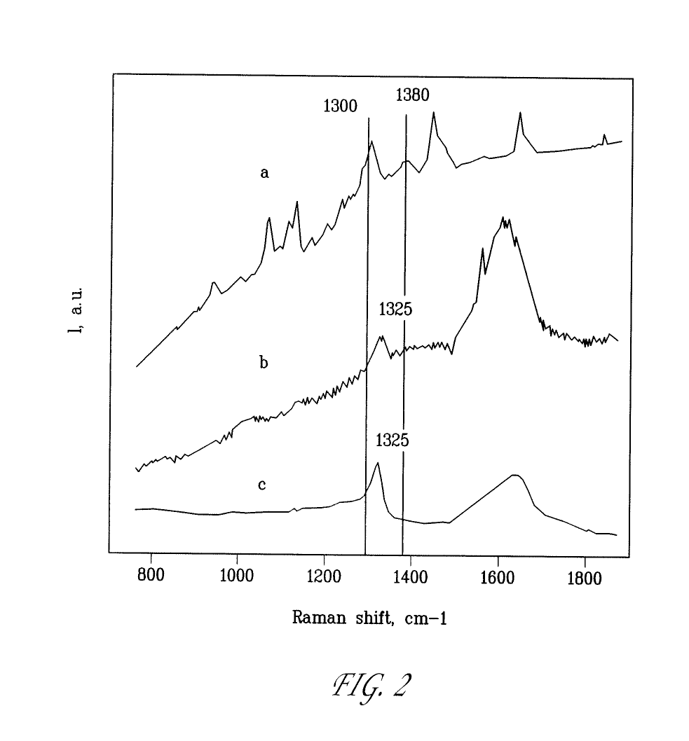

In FIG. 2, the G-band was weak and not seen. The Raman spectra of Nylon-11 showed a high fluorescence and peaks for the polymer could interfere with the ND peaks (curve a in FIG. 2). Therefore, the coating was dissolved in a 1:1 by volume mixture of formic acid and dichloromethane. The Raman spectra were collected after rinsing the resulting powder several times with fresh solvent (FIG. 2(b)). The peak at 1325 cm-1 shown in FIG. 2(b) was related to the ND, thus confirming the presence of the diamond phase in the sprayed coating. The presence of a low intensity G-band (˜1600 cm⁻¹) peak in FIG. 2(b) led to the conclusion that the HVOF process did not result in graphitization of the nanodiamond. This was between the peaks from the polymer corresponding to the C—N (1310-1350 cm⁻¹) and N—H bending region (1440-1490 cm-1).

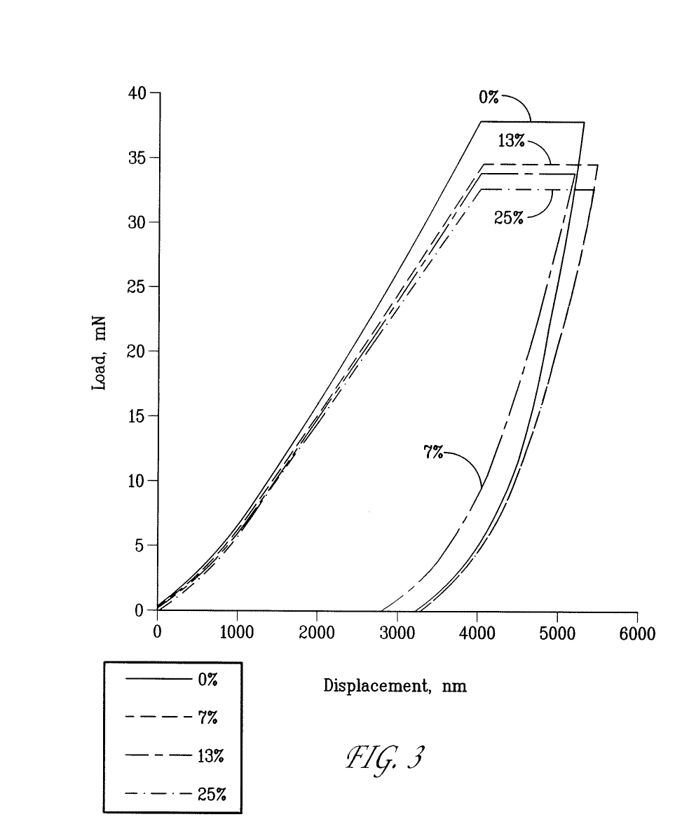

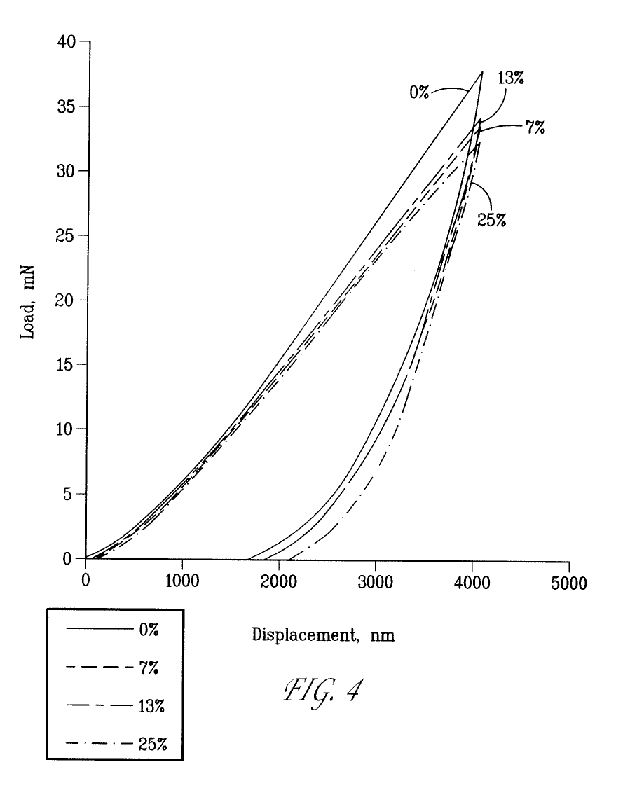

FIG. 3 shows the typical loading-hold-unloading nanoindentation curve for coatings with different nanodiamond contents. When the load was removed from the indenter, the material attempted to return to its original shape, but usually the recovery was not 100%, indicating a level of plastic deformation. Different materials are characterized by different degrees of recovery due to a relaxation of the elastic strains within the materials. A difference in the elastic recovery of the materials was observed from the indentation curves. In order to better visualize the recovery part, FIG. 4 shows the indentation curves for the coatings without the holding segment.

The recovery at zero load and the recovery at full unloading are reported in Table 1. The data were the mean of 10 indents for each sample and are presented as a percentage of the total depth (Recovery*100/total depth). It can be seen that the presence of nanodiamond influenced the viscoelastic behavior of the polymer. There was less dissipation of energy during the deformation process. In general, it appeared that coatings with higher nanodiamond contents returned more energy at the end of the unloading cycle. This resulted in a decrease in the depth of the residual deformation compared to that for the pure polymer.

The length of the deformation zone at the maximum load divided by time (the average creep rate) is reported in the Table 1. There was a slight decrease of the creep rate for the sample containing 7 wt. % of nanodiamond.

TABLE 1
Elastic recovery and average creep rate of the coatings.

| Nanodiamond | Recovery at | Recovery at | Average |
|---|---|---|---|
| loading | Zero load | Full unload | Creep rate |
| (wt. %) | (%) | (%) | (nm/s) |
| 0% | 49 | 82 | 1.21 ± 0.03 |
| 7% | 56 | 88 | 1.12 ± 0.03 |
| 13% | 56 | 93 | 1.41 ± 0.03 |
| 25% | 50 | 87 | 1.32 ± 0.04 |

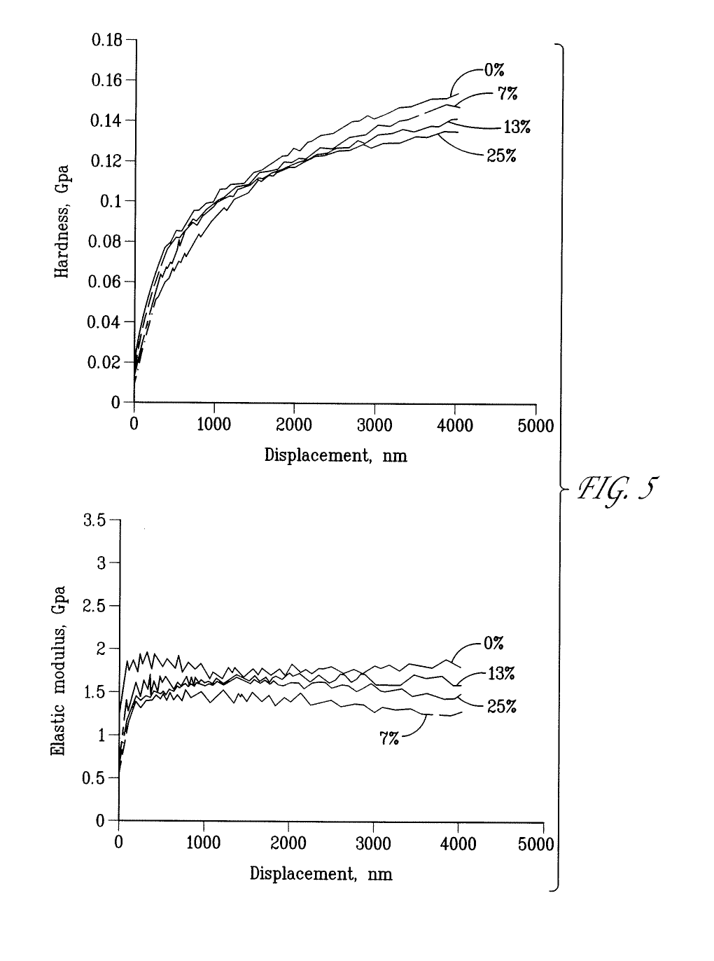

The hardness and modulus, calculated from the continuous stress measurement (CSM), are reported in FIG. 5.

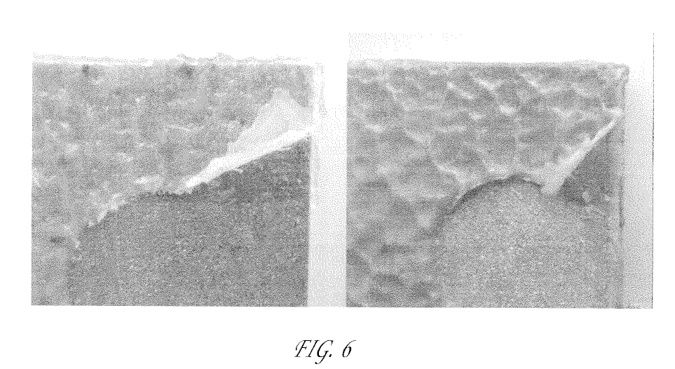

Another significant property of sprayed coatings is their adhesion to the substrate. For the HVOF coatings produced in this work, their adhesion to the substrate was significantly improved upon addition of the nanodiamond. FIG. 6 shows and compares optical images of a coating with 7 wt. % of nanodiamond and a pure Nylon-11 coating sprayed using the same parameters. Small regions of the coatings were peeled off using a razor blade. The sprayed pure Nylon-11 coating was readily peeled off whereas the Nylon-11/nanodiamond composite coating could not be peeled off at all without scratching the underlying metallic substrate, qualitatively indicating significantly improved adhesion in the latter case.

The properties of nanodiamonds are determined in part by their surface chemistry and functional groups. The surface of the nanoparticles contributes to their dispersion/agglomeration behavior in solvents, their interaction with the environment, their biocompatibility and their ability to form strong covalent bonds with a matrix in composites. Thus, nanodiamonds are purified and the surface chemistry of the nanodiamonds is controlled. For example, the majority of the surface functionalities were converted to —COOH groups. Subsequent treatment with a dilute HCl removed the metallic impurities which were initially protected by graphitic carbon shells. Carboxyl groups at the surface of ND are believed to interact with the nitrogen atoms present in the amide bonds in the backbone of the Nylon-11 chain through the formation of hydrogen bonds. The formation of hydrogen bonds promises stronger interactions between the polymer and nanodiamond particles and more uniform distribution of the particles within the polymer matrix.

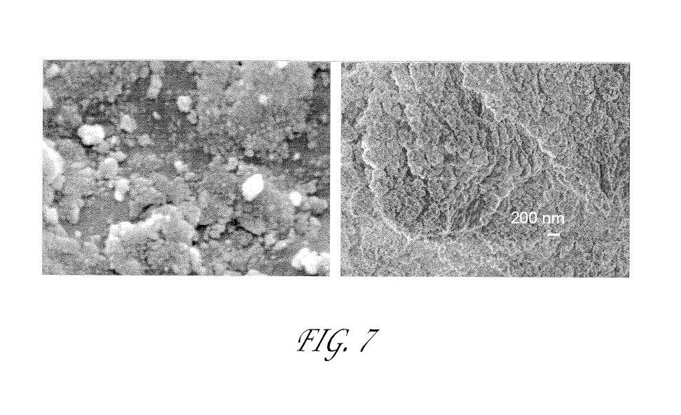

Scanning electron microscopy analysis in FIG. 7 showed that that the use of oxidized, HCl treated UD90 nanodiamond resulted in improved distribution of the nanoparticles as compared to the as-received ND sample. Consequently, it is believed that substitution of the as-received UD90 with the oxidized and HCl treated UD90 will result in further improvement in properties of HVOF sprayed ND-containing Nylon-11 coatings.

### REFERENCES

Danilenko, V. V., Specific Features of Synthesis of Detonation Nanodiamonds, Combustion Explosion and Shock Waves, (2005), 41 (5), pp. 577-588.

Post, G., Dolmatov, V. Yu., Marchukov, V. A., Sushchev, V. G. and Veretennikova, M. V., Industrial Synthesis of Ultradisperse Detonation Diamonds and Some Fields of Their Use, Russian J. Applied Chemistry, (2002), 75 (5), pp. 755-760.

Livramento, V., Correia, J. B., Shohoji, N. and Ōsawa, E., Nanodiamond as an Effective Reinforcing Component for Nano-Copper, Diamond and Related Materials, (2007), 16, pp. 202-204.

Petrovicova, E., Knight, R., Schadler, L. S. and Twardowski, T. E., Nylon-11/Silica Nanocomposite Coatings Applied by the HVOF Process I: Microstructure and Morphology, J. Applied Polymer Sci., (2000), 77, pp. 1684-1699.

Petrovicova, E., Knight, R., Schadler L. S. and Twardowski, T. E., Nylon-11/Silica Nanocomposite Coatings Applied by the HVOF Process II: Mechanical and Barrier Properties, J. Applied Polymer Sci., (2000), 78, pp. 2272-2289.

Ivosevic, N., Cairncross, R. A. and Knight, R., Melting and Degradation of Nylon-11 Particles during HVOF Combustion Spraying, Proc. 2007 Int'l Thermal Spray Conf., (ITSC-2007), Beijing, ASM International, (2007), pp. 820-825.

Osswald, S. et al., Control of sp2/sp3 Carbon Ratio and Surface Chemistry of Nanodiamond Powders by Selective Oxidation in Air, J. Am. Chem. Soc., (2006), 128 (35), pp. 11635-11642.

Fischer-Cripps, A. C., A Review of Analysis Methods for Sub-Micron Indentation Testing, Vacuum, (2000). 58, pp. 569-585.

Ya, V., Shevchenko, V. Ya., Madison A. E., and Yur'ev, G. S., Structure of Nanodiamonds, Glass Physics and Chemistry, (2006), 32, pp. 261-166.

Gogotsi, Y., Klaus, T. K., Nickel, G. and Zvanut, M. E., Hydrothermal Behavior of Diamond, Diamond and Related Materials, (1998), 7, pp. 1459-1465.

Stephens, J. S., Chase D. B. and Rabolt, J. F., Effect of the Electrospinning Process on Polymer Crystallization Chain Conformation in Nylon-6 and Nylon-12, Macromolecules, (2004), 37, pp. 877-881.

What is claimed:

1. An article of manufacture at least one surface of which having a coating thereupon comprising nanodiamonds in admixture with at least one polymer.

2. The article of claim 1, wherein the coating is applied via thermal spraying.

3. The article of claim 1, wherein the coating is applied via high-velocity oxy-fuel combustion spraying.

4. The article of claim 1, wherein at least one polymer comprises poly(ethylene), poly(propylene), thermoplastic poly(urethane), poly(amide), poly(imide), alkylene tetrafluoroethylene, or poly(carbonate).

5. The article of claim 1, wherein at least one polymer comprises polyamide-11.

6. The article of claim 1, wherein at least one nanodiamond is functionalized.

7. The article of claim 6, wherein at least one nanodiamond is oxidized.

8. The article of claim 1, wherein at least one nanodiamond is covalently bonded to at least one polymer.

9. The article of claim 1, wherein at least one surface of the article of manufacture having a coating thereupon comprises at least one of a metal, a ceramic, a polymer, or a composite.

10. The article of claim 1, wherein the admixture is accomplished by dispersion of the nanodiamonds among particles comprising at least one polymer.

11. The article of claim 1, wherein the volume percent of nanodiamonds in the admixture of nanodiamonds and at least one polymer is in the range from between about 0.1 percent to about 99.9 percent.

12. The article of claim 1, wherein the volume percent of nanodiamonds in the admixture of nanodiamonds and at least one polymer is in the range from between about 2.5 percent to about 10 percent.

13. The article of claim 1, wherein at least one nanodiamond comprises a characteristic cross-sectional dimension in the range of from about 1 nm to about 50 nm.

14. The article of claim 1, wherein at least one nanodiamond comprises a characteristic cross-sectional dimension in the range of from about 5 nm to about 20 nm.

15. A method for coating at least a portion of an article comprising contacting the portion with nanodiamonds and at least one polymer via thermal spraying.

16. The method of claim 15, wherein the thermal spraying is high-velocity oxy-fuel combustion spraying.

17. The method of claim 15, wherein at least one polymer comprises poly(ethylene), poly(propylene), thermoplastic poly(urethane), poly(amide), poly(imide), alkylene tetrafluoroethylene, or poly(carbonate).

18. The method of claim 15, wherein at least one polymer comprises polyamide-11.

19. The method of claim 15, wherein the nanodiamonds are covalently bonded to at least one polymer.

20. The method of claim 15, wherein at least one nanodiamond comprises a characteristic cross-sectional dimension in the range of from about 1 nm to about 50 nm.

21. The method of claim 15, wherein at least one nanodiamond comprises a characteristic cross-sectional dimension in the range of from about 5 nm to about 20 nm.

22. A composition of matter comprising polymer particles and nanodiamonds embedded in the surfaces of the polymer particles.

23. The composition of claim 22, wherein the polymer particles comprise at least one of poly(ethylene), poly(propylene), thermoplastic poly(urethane), poly(amide), poly(imide), alkylene tetrafluoroethylene, or poly(carbonate).

24. The composition of claim 22, wherein the polymer particles comprise polyamide-11.

25. The composition of claim 22, wherein the polymer particles comprise particles having mean particle sizes in the range from about 30 μm to about 120 μm.

26. The composition of claim 22, wherein the polymer particles comprise particles having mean particle sizes of about 80 μm.

27. The composition of claim 22, wherein the polymer particles are heated above about 100° C. and accelerated via thermal spraying.

28. The composition of claim 22, wherein at least one nanodiamond comprises a characteristic cross-sectional dimension in the range of from about 1 nm to about 50 nm.

29. The composition of claim 22, wherein at least one nanodiamond comprises a characteristic cross-sectional dimension in the range of from about 5 nm to about 20 nm.

30. A composition of matter comprising polymer particles covalently bonded to functionalized nanodiamonds.

31. The composition of claim 30, wherein the functionalized nanodiamonds comprise oxidized nanodiamonds.

32. The composition of claim 31, wherein the composition is a solid powder produced by drying a solution comprising water, the oxidized nanodiamonds, and the polymer particles.

33. The composition of claim 32, wherein the polymer particles comprise at least one of poly(ethylene), poly(propylene), thermoplastic poly(urethane), poly(amide), poly(imide), alkylene tetrafluoroethylene, or poly(carbonate).

34. The composition of claim 32, wherein the polymer particles comprise polyamide-11.

35. The composition of claim 32, wherein the polymer particles comprise particles having mean particle sizes in the range from about 30 μm to about 120 μm.

36. The composition of claim 32, wherein the polymer particles comprise particles having mean particle sizes of about 80 μm.

37. The composition of claim 32, wherein the polymer particles are heated above about 100° C. and accelerated via thermal spraying.

38. The composition of claim 32, wherein at least one nanodiamond comprises a characteristic cross-sectional dimension in the range of from about 1 nm to about 50 nm.

39. The composition of claim 32, wherein at least one nanodiamond comprises a characteristic cross-sectional dimension in the range of from about 5 nm to about 20 nm.

40. A method comprising coating a surface with an article of manufacture comprising polymer particles and nanodiamonds embedded in the surfaces of the polymer particles.

41. The method of claim 40, wherein the surface is coated by thermal spraying

42. The method of claim 40, wherein the surface is coated by high-velocity oxy-fuel combustion spraying.

43. The method of claim 40, wherein the polymer particles comprise at least one of poly(ethylene), poly(propylene), thermoplastic poly(urethane), poly(amide), poly(imide), alkylene tetrafluoroethylene, or poly(carbonate).

44. The method of claim 40, wherein the polymer particles comprise polyamide-11.

45. The method of claim 40, wherein the nanodiamonds comprise functionalized nanodiamonds.

46. The method of claim 40, wherein the nanodiamonds comprise oxidized nanodiamonds.

47. The method of claim 40, wherein the nanodiamonds further comprise nanodiamonds covalently bonded to the surfaces of the polymer particles.

48. The method of claim 40, wherein at least one nanodiamond comprises a characteristic cross-sectional dimension in the range of from about 1 nm to about 50 nm.

49. The method of claim 40, wherein at least one nanodiamond comprises a characteristic cross-sectional dimension in the range of from about 5 nm to about 20 nm.
